(19) United States
(12) Patent Application Publication
(10) Pub. No.: US 2011/0215204 A1
(43) Pub. Date: Sep. 8, 2011

(54) SYSTEM AND METHOD FOR GENERATING THRUST

(75) Inventor: Andrei Tristan Evulet, Firenze (IT)

(73) Assignee: GENERAL ELECTRIC COMPANY, SCHENECTADY, NY (US)

(21) Appl. No.: 13/109,316

(22) Filed: May 17, 2011

Related U.S. Application Data
(63) Continuation-in-part of application No. 11/765,666, filed on Jun. 20, 2007, now abandoned.

(51) Int. Cl. B64D 33/02; F02K 1/38

(52) U.S. Cl. 244/53 B; 60/264; 60/204

(57) ABSTRACT

A thrust generator includes an air inlet configured to introduce air within the thrust generator and a plenum having a plurality of fluid injection devices. The plenum is configured to receive an exhaust gas from a gas generator and direct the exhaust gas via the plurality of fluid injection devices radially into the thrust generator and along a Coanda profile surface configured to facilitate attachment of the exhaust gas to the profile surface to form a boundary layer and to entrain incoming air from the air inlet to generate thrust. The thrust generator has a non-circular shape.

### CROSS REFERENCE TO RELATED APPLICATIONS

This application is a continuation-in-part of U.S. patent application Ser. No. 11/765,666, entitled “THRUST GENERATOR FOR A PROPULSION SYSTEM”, filed Jun. 20, 2007, which is herein incorporated by reference.

### BACKGROUND

The invention relates generally to propulsion systems, and more particularly, to a system and method for generating thrust in a propulsion system.

In propulsion systems, for example, in a jet aircraft powered by a turbojet engine, air enters through an intake device and then compressed to a higher pressure via a rotating compressor. The compressed air is fed to a combustor where the air is mixed with a fuel and ignited. The generated hot combustion gases from the combustor are then fed to a turbine, where power is extracted to drive the compressor. The exhaust gases from the turbine are accelerated through a nozzle to provide thrust for the jet aircraft. Further, the exhaust gas flow is expanded to atmospheric pressure through the propelling nozzle that produces a net thrust to drive the jet aircraft.

An aircraft includes a plurality of thrust generators configured to receive the exhaust gas from the gas generator to generate thrust for driving the aircraft. Each of the thrust generators is configured to utilize the exhaust gas from the gas generator to entrain incoming air to generate a high velocity flow using a Coanda profile. “Coanda profile” refers to a profile that is configured to facilitate attachment of a stream of fluid to a nearby surface and to remain attached even when the surface curves away from the original direction of fluid motion.

Coanda type thrust generators use a continuous annulus slot for injecting the primary fluid. Such systems have drawbacks associated with limited injection velocity of the primary fluid, low entrainment of a secondary fluid with the primary fluid, and poor mixing of the primary and secondary fluids. Such systems have limitations in the efficiency and amount of thrust that can be generated.

Accordingly, there is a need for an improved thrust generation system that enhances propulsion efficiency and low specific fuel consumption in a propulsion system.

### BRIEF DESCRIPTION

In accordance with one exemplary embodiment of the present invention, a thrust generator includes an air inlet configured to introduce air within the thrust generator and a plenum having a plurality of fluid injection devices. The plenum is configured to receive an exhaust gas from a gas generator and direct the exhaust gas via the plurality of fluid injection devices radially into the thrust generator and along a Coanda profile surface configured to facilitate attachment of the exhaust gas to the profile surface to form a boundary layer and to entrain incoming air from the air inlet to generate thrust. The thrust generator has a non-circular shape.

In accordance with another exemplary embodiment of the present invention, an aircraft is disclosed. The aircraft includes an aircraft frame, and a gas generator coupled to the aircraft frame and configured to generate an exhaust gas. The aircraft further includes the exemplary thrust generator coupled to the aircraft frame.

In accordance with another exemplary embodiment of the present invention, a method for generating thrust is disclosed. The method includes introducing air via an air inlet with a non-circular thrust generator. The method also includes directing exhaust gas from a gas generator to a plenum. The method further includes injecting the exhaust gas from the plenum via the plurality of fluid injection devices radially into the thrust generator and along a Coanda profile surface configured to facilitate attachment of the exhaust gas to the profile surface to form a boundary layer and to entrain incoming air from the air inlet.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical illustration of an aircraft having a plurality of thrust generators in accordance with aspects of the present technique.

FIG. 2 is a diagrammatical illustration of an aircraft having a plurality of thrust generators in accordance with aspects of the present technique.

FIG. 3 is a diagrammatical illustration of an exemplary configuration of a thrust generator of the aircraft of FIG. 1 in accordance with aspects of the present technique.

FIG. 4 is a diagrammatical illustration of exhaust gas flow introduction from a gas generator in accordance with aspects of the present technique.

FIG. 5 is a diagrammatical illustration of a nozzle of the thrust generator with the aircraft of FIG. 1 in accordance with aspects of the present technique.

FIG. 6 is a diagrammatical illustration of an exemplary configuration of the nozzle of the thrust generator of FIG. 1 in accordance with aspects of the present technique.

FIG. 7 is a block diagram illustrating introduction of exhaust gases during the operation of the thrust generator of FIG. 5 in accordance with aspects of the present technique.

FIG. 8 is a diagrammatical illustration of an injection nozzle in accordance with the aspects of the present technique.

FIG. 9 is a diagrammatical illustration of introduction of exhaust gases within the thrust generator in accordance with aspects of the present technique.

FIG. 10 is a diagrammatical illustration of the formation of boundary layer adjacent a Coanda profile in the thrust generator in accordance with aspects of the present technique.

### DETAILED DESCRIPTION

As discussed in detail below, embodiments of the present invention function to enhance efficiency of a propulsion system such as a jet aircraft powered by a turbojet engine. In particular, the present invention utilizes the combination of a working fluid and ambient air to generate thrust for driving the propulsion system thereby enhancing the efficiency and reducing specific fuel consumption of such system.

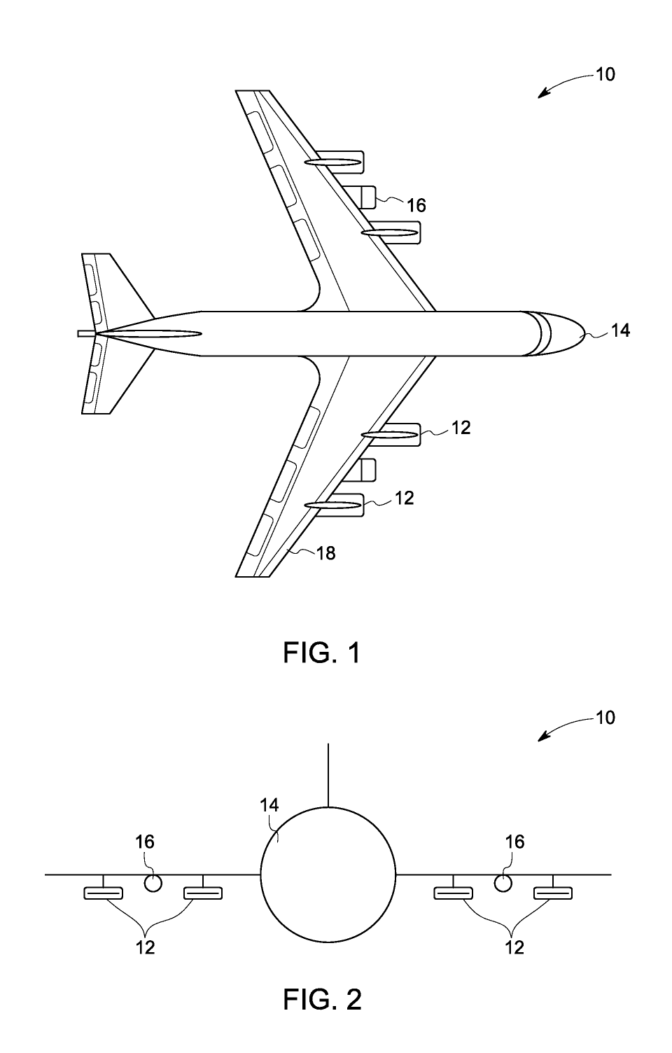

Referring to FIG. 1, an aircraft 10 having a plurality of thrust generators represented by reference numeral 12 is illustrated. The aircraft 10 includes an aircraft frame 14 and one or more gas generators 16 coupled to the aircraft frame 14. In one exemplary embodiment, the gas generator 16 may include a jet engine that is configured to generate an exhaust gas.

In the illustrated embodiment, the plurality of thrust generators 12 are coupled to the plurality of wings 18 of the aircraft 10 and are configured to receive the exhaust gas from the gas generator 16 to generate thrust for driving the aircraft 10. The number of thrust generators 12 may vary depending on the application. Further, in certain embodiments, the plurality of thrust generators 12 may be disposed on a fuselage of the aircraft 10. Each thrust generator 12 is configured to utilize the exhaust gas from the gas generator 16 to entrain incoming air to generate a high velocity flow using a Coanda profile that will be described below. As used herein, the term “Coanda profile” refers to a profile that is configured to facilitate attachment of a stream of fluid or a wall jet to a nearby surface and to remain attached even when the surface curves away from the original direction of fluid motion. In some embodiments, the plurality of thrust generators 12 are configured to generate the overall thrust required for driving the aircraft 10 by utilizing the exhaust gas from the gas generator 30. It should be noted that in the embodiments discussed herein, that the plurality of thrust generators 12 have a non-circular shape.

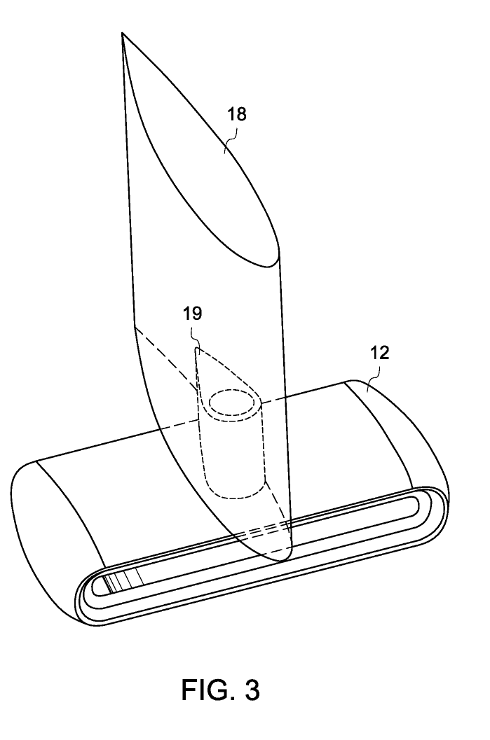

Referring to FIG. 2, the aircraft 10 having the plurality of thrust generators 12 is illustrated. As discussed in FIG. 1, one or more gas generators 16 coupled to the aircraft frame 14. The plurality of thrust generators 12 are coupled to the plurality of wings 18 of the aircraft 10. The plurality of thrust generators 12 have a non-circular shape.

Referring to FIG. 3, one thrust generator 12 is shown integrated with the wing 18 of the aircraft. As discussed previously, the thrust generator 12 is a non-circular shaped thrust generator. In the illustrated embodiment, the thrust generator 12 is a flat device. In other embodiments, other non-circular shapes of the thrust generator 12 are also envisaged. It should be noted herein that the non-circular shape of the thrust generator 12 facilitates the thrust generator 12 to be embedded within the wing 18 or fuselage of the aircraft. In the illustrated embodiment, an inlet port 19 is coupled to the wing 18 and configured to direct the exhaust gas from the gas generator 16 into the thrust generator 12.

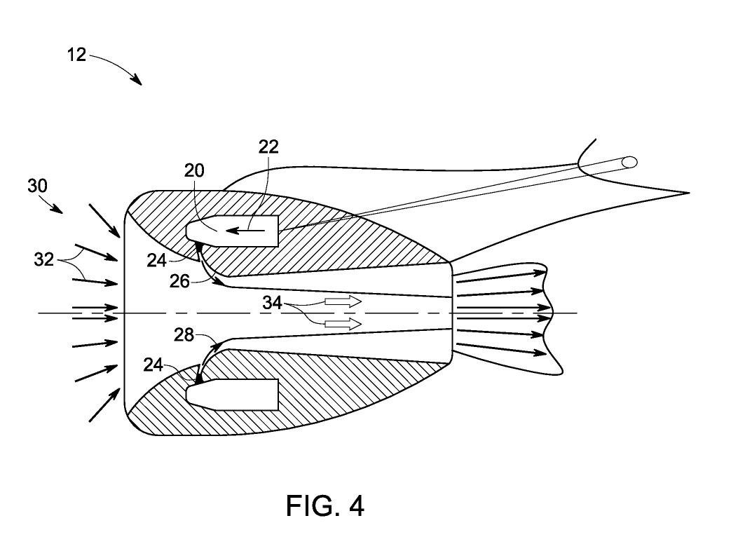

FIG. 4 is a diagrammatical illustration of an exemplary thrust generator 12 of the aircraft 10 of FIG. 1 in accordance with aspects of the present invention. As illustrated, the thrust generator 12 includes a plenum 20 that is configured to receive an exhaust gas 22 fed from the gas generator. In the illustrated embodiment, a plurality of injection devices (guiding nozzles) 24 are configured to direct the exhaust gas 22 radially into the thrust generator and over a Coanda profile surface 26 that is configured to facilitate attachment of the exhaust gas 22 to the profile surface 26. In one exemplary embodiment, the Coanda profile surface 26 includes a logarithmic profile. The pressurized flow of the exhaust gas 22 from the plenum 20 is introduced along the Coanda profile surface 26 as represented by reference numeral 28. The thrust generator 12 includes an air inlet 30 for entraining airflow 32 within the thrust generator 12.

In some embodiments, a fuel and/or water may be fed into the plenum 20. In a specific embodiment, the fuel and exhaust gas is combusted in the plenum 20 and a generated combustion gas is injected into the thrust generator 12 via the plurality of injection devices 24. In another specific embodiment, water and exhaust gas is combusted in the plenum 20 and a generated mixture of steam and exhaust gas is injected into the thrust generator 12 via the plurality of injection devices 24. The injection of a fuel and/or water into the plenum 20 facilitates to increase mass flow rate through the thrust generator 12 during take-off of the aircraft 10 resulting in substantial thrust augmentation. After take-off of the aircraft 10, the fuel and/or water are not needed, unless in case of an emergency condition. In effect, the plenum 20 acts as a “combustion chamber” that can be used as a “reheat device” for thrust augmentation.

In the illustrated embodiment, the plurality of injection devices 24 includes a plurality of injection nozzles. The size and positions of an exit of each nozzle 24 may be altered so as to accelerate or decelerate the flow velocity of exhaust gas 22 into the thrust generator 12. The technique for altering the size of the exit of each nozzle 24 is explained below with reference to subsequent figures.

During operation, the pressurized exhaust gas 28 entrains airflow 32 to generate high velocity airflow 34. In particular, the Coanda profile surface 26 enables mixing of the pressurized exhaust gas 28 with the entrained airflow 32 and generates the high velocity airflow 34 by transferring the energy and momentum from the pressurized exhaust gas 28 to the airflow 32. In the exemplary embodiment, the Coanda profile surface 26 facilitates attachment of the pressurized exhaust gas 28 to the profile surface 26 until a point where the velocity of the flow drops to a fraction of the initial velocity while imparting momentum and energy to the airflow 32. It should be noted that the thrust generator 12 is operated in such a way so as to enhance the acceleration of incoming airflow 32 that flows from an ambient condition to an outlet of the thrust generator 12 to enhance thrust. In certain embodiments, introduction of heat using the exhaust gas 22 into the plenum 20 will increase the energy and result in the exhaust gas 22 entraining more air or accelerating the air to higher velocities.

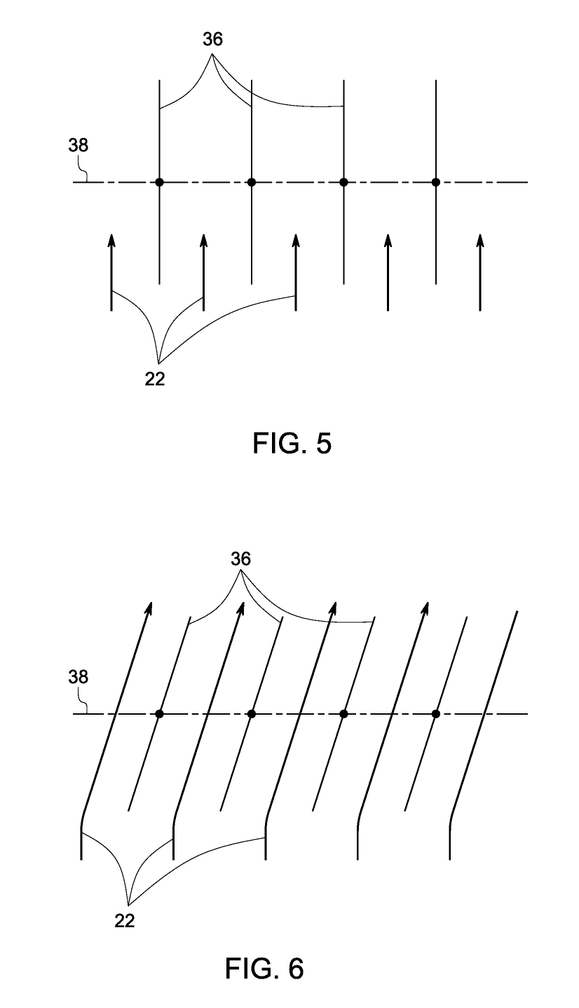

FIG. 5 is a diagrammatical representation of a nozzle vane 36 of the nozzle 24 (shown in FIG. 4). In the illustrated embodiment, the nozzle vane 36 is shown in a perpendicular position relative to a central axis 38. When the nozzle vane 36 is held in the perpendicular position, the exhaust gas 22 is injected from the nozzle along a perpendicular direction relative to the central axis 38.

FIG. 6 is a diagrammatical representation of the nozzle vane 36 of the nozzle 24 (shown in FIG. 4). In the illustrated embodiment, nozzle vane 36 is shown in a tilted position relative to the central axis 38 (shown in FIG. 5). When the nozzle vane 36 is held in a tilted position, a swirl is imparted to the flow of the exhaust gas 22 from the nozzle. This swirl motion enhances the entrainment of the airflow with the flow of exhaust gas. Hence thrust is accordingly increased.

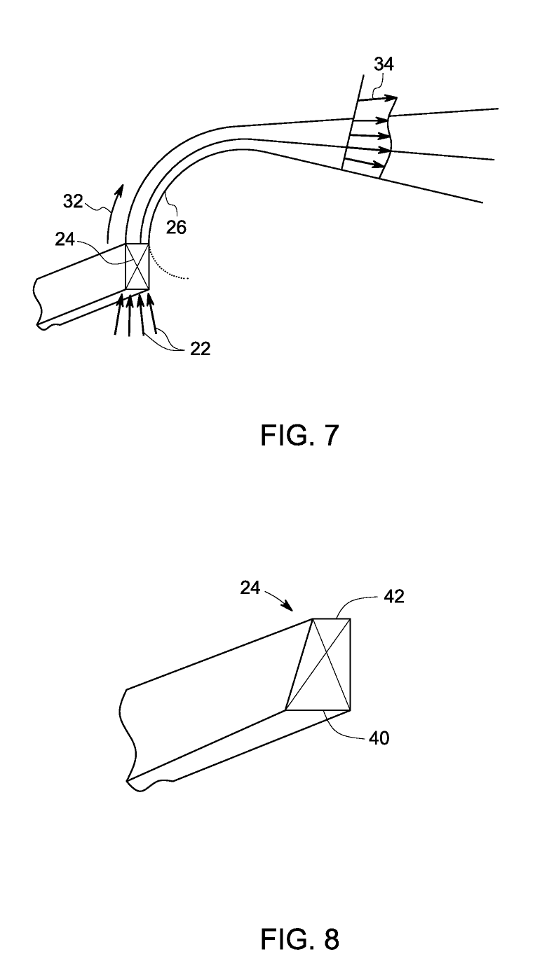

FIG. 7 is a diagrammatical illustration of the injection nozzle 24 of the plenum configured to inject exhaust gas radially into the thrust generator and along the Coanda profile surface 26 of the thrust generator. As illustrated, the exhaust gas 22 from the plenum is directed into the thrust generator and along the Coanda profile 26. The exhaust gas 22 is directed radially into the axis of the thrust generator and along the Coanda profile surface 26 via the plurality of individually distributed nozzles 24. It should be noted that in such a configuration, there is reduction in the initial velocity of the exhaust gas 22 due to entrainment of slower airflow 32 and transfer of momentum and energy to entrained airflow 32, as well as due to some friction losses at walls of the thrust generator. Furthermore, the high velocity exhaust gas 22 from the plenum generates a low pressure zone due the curvature of the flow along the Coanda profile surface 26 that aids in the entrainment of air flow 32. In such an embodiment, a particular velocity is imposed on the flow of the exhaust gas 22 due to a pressure drop across the nozzle 24 resulting in entrainment of the airflow 32 with the flow of exhaust gas 22. Thereby thrust is generated.

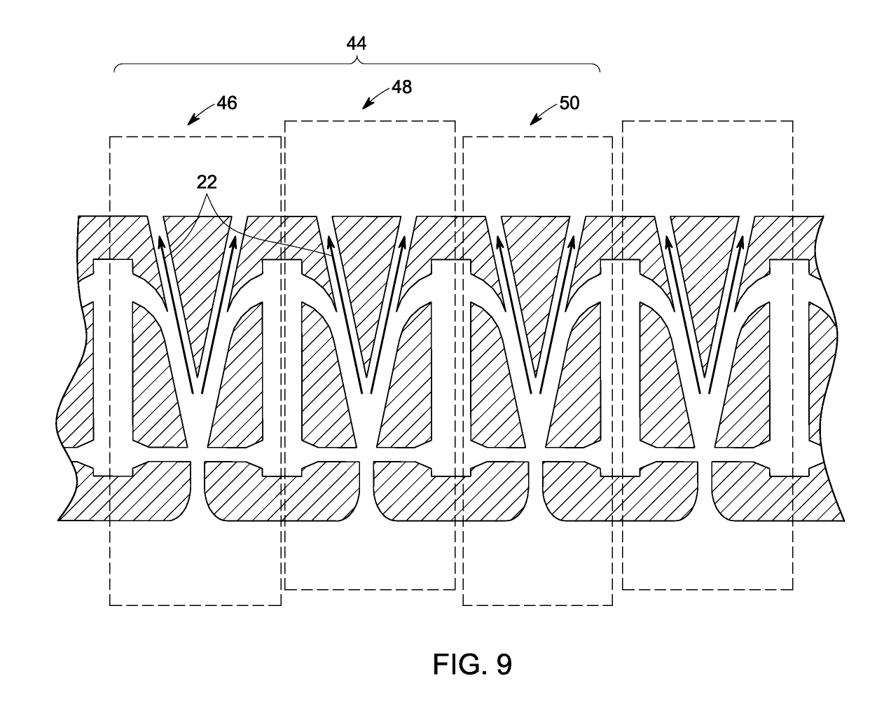

See FIG. 8 is a diagrammatical representation of the injection nozzle 24 in accordance with the aspects of FIG. 7. The injection nozzle 24 has an inlet 40 and an exit 42. In the illustrated embodiment, the size of the exit 42 of the injection nozzle 24 is altered i. e. reduced by actuating one or more nozzle vanes 36 (shown in FIGS. 5 and 6). In such an embodiment, the velocity of the exhaust gas 22 is increased due to reduction in the size of the exit 42 of the injection nozzle 24 resulting in enhanced entrainment of the airflow 32 with the flow of exhaust gas 22. Thereby substantial thrust is generated.

In some embodiments, when higher amount of flow of exhaust gas 22 is required, all the injection nozzles 24 may be opened. In some other embodiments, when only lower amount of flow of the exhaust gas 22 is required, some injection nozzles 24 may be closed and the remaining injection nozzles 24 may be opened. The nozzles 24 may be selectively opened and closed by controlling the actuation of the corresponding nozzle vanes. In certain embodiments, during a take-off operation of the aircraft, the opening/closing of the injection nozzles 24, and the acceleration of the flow of the exhaust gas 22 may be controlled by actuation of the nozzle vanes so as to generate substantial thrust.

FIG. 9 is a diagrammatical view of an array 44 of injection devices in accordance with an exemplary embodiment of the present invention. In the illustrated embodiment, the array 44 includes a plurality of fluidic oscillators including a first fluidic oscillator 46, a second fluidic oscillator 48, a third fluidic oscillator 50 and so on. Similar to the embodiment of FIG. 4, the plurality of injection devices 44 configured to direct pulsed jets of the exhaust gas 22 radially into the thrust generator and over the Coanda profile surface that is configured to facilitate attachment of the exhaust gas 22 to the Coanda profile surface. The operation of one exemplary type of fluidic oscillator is described in U.S. Pat. No. 7,128,082 entitled “Method and System for Flow Control with Fluidic Oscillators”, which is incorporated in its entirety herein by reference.

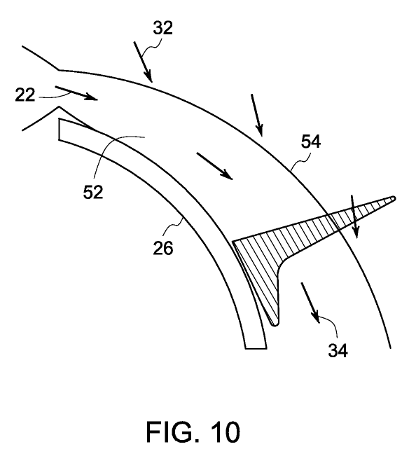

FIG. 10 is a diagrammatical illustration of the formation of boundary layer 52 adjacent the Coanda profile surface 26 in the thrust generator based upon the Coanda effect. In the illustrated embodiment, the exhaust gas 22 attach to the Coanda profile surface 26 and remain attached even when the surface of the Coanda profile surface 26 curves away from the initial fuel flow direction. More specifically, as the exhaust gases 22 decelerate there is a pressure difference across the flow, which deflects the exhaust gas 22 closer to the surface of the Coanda profile surface 26. As will be appreciated by one skilled in the art, as the exhaust gas 22 move across the Coanda profile surface 26, a certain amount of skin friction occurs between the exhaust gas 22 and the Coanda profile surface 26. This resistance to the flow deflects the exhaust gas 22 towards the Coanda profile surface 26 thereby causing it to stick to the Coanda profile surface 26. Further, the boundary layer 52 formed by this mechanism entrains incoming airflow 32 to form a shear layer 54 with the boundary layer 52 to promote entrainment and mixing of the airflow 32 and exhaust gas 22. Furthermore, the shear layer 54 formed by the detachment and mixing of the boundary layer 52 with the entrained air 32 generates a high velocity airflow 34 that is utilized for enhancing efficiency of a propulsion system by generating thrust.

The air entrained in the core of the thrust generator will thus be at lower velocities at a take off condition of the aircraft but at much higher velocities in flight, making the entrainment and transfer of momentum from the driving exhaust gases very efficient and the difference between the aircraft velocity and emerging jet velocity relatively smaller. This translates into a higher propulsive efficiency for the thrust generator. The thrust generator described above facilitates entrainment of air through the exhaust gases.

By introducing the exhaust gas flow over the Coanda profile surface 26 via individual fluid injection devices such as injection nozzles, fluidic oscillators, a strong acceleration of the exhaust gas flow results, which facilitates entrainment of incoming air in between these individual jets. Further, the incoming air is accelerated and is expelled at an exit of the Coanda profile at pressures close to the ambient pressure. Beneficially, the entrainment of air, rapid transfer of energy and momentum through the thrust generator and a low pressure drop across the thrust generator results in enhanced thrust generation.

The various aspects of the method described hereinabove have utility in enhancing efficiency of different propulsion systems such as aircrafts, under water propulsion systems and rocket and missiles. The technique described above employs a thrust generator that can be integrated with existing propulsion systems and utilizes a driving fluid such as exhaust gas from a gas generator to entrain a secondary fluid flow for generating a high velocity airflow. In particular, the non-circular thrust generator employs a plurality of fluid injection devices such as injection nozzles, fluidic oscillators to accelerate the injection of exhaust gas and also utilize the Coanda effect to generate the high velocity airflow that may be used for generating thrust thereby enhancing the efficiency of such systems.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A thrust generator, comprising:
an air inlet configured to introduce air within the thrust generator; and
a plenum comprising a plurality of fluid injection devices, wherein the plenum is configured to receive an exhaust gas from a gas generator and direct the exhaust gas via the plurality of fluid injection devices radially into the thrust generator and along a Coanda profile surface configured to facilitate attachment of the exhaust gas to the profile surface to form a boundary layer and to entrain incoming air from the air inlet to generate thrust; wherein the thrust generator has a non-circular shape.

2. The thrust generator of claim 1, wherein the thrust generator comprises a flat device.

3. The thrust generator of claim 1, wherein the plurality of fluid injection devices comprises a plurality of fluidic oscillators configured to inject pulsed jets of the exhaust gas radially into the thrust generator and along the Coanda profile surface at a predetermined modulated frequency.

4. The thrust generator of claim 1, wherein the plurality of fluid injection devices comprises a plurality of nozzles configured to direct the exhaust gas radially into the thrust generator and along the Coanda profile surface.

5. The thrust generator of claim 4, wherein each nozzle among the plurality of nozzles comprises one or more nozzle vanes; wherein the one or more nozzle vanes are actuated to alter size of an exit of each nozzle.

6. The thrust generator of claim 5, wherein the one or more of nozzle vanes are actuated to reduce the size of the exit of each nozzle so as to accelerate the injection of the exhaust gas radially into the thrust generator and along the Coanda profile surface.

7. The thrust generator of claim 5, wherein the one or more nozzle vanes of each nozzle are selectively actuatable in such a way that only some nozzles among the plurality of nozzles inject the exhaust gas into the thrust generator.

8. The thrust generator of 5, wherein the one or more nozzle vanes of each nozzle are actuated to impart swirl motion to the flow of the exhaust gas.

9. The thrust generator of claim 1, wherein the plenum is further configured to receive the exhaust gas and a fuel, combust the exhaust gas and the fuel to generate a combustion gas, and inject the combustion gas into the thrust generator.

10. The thrust generator of claim 1, wherein the plenum is further configured to receive the exhaust gas and water, combust the exhaust gas and water to generate a mixture of steam and the exhaust gas, and inject the mixture of steam and the exhaust gas into the thrust generator.

11. An aircraft, comprising:
an aircraft frame;
a gas generator coupled to the aircraft frame and configured to generate an exhaust gas; and
a thrust generator coupled to the aircraft frame, the thrust generator comprising:
an air inlet configured to introduce air within the thrust generator; and
a plenum comprising a plurality of fluid injection devices, wherein the plenum is configured to receive an exhaust gas from the gas generator and direct the exhaust gas via the plurality of fluid injection devices radially into the thrust generator and along a Coanda profile surface configured to facilitate attachment of the exhaust gas to the profile surface to form a boundary layer and to entrain incoming air from the air inlet to generate thrust; wherein the thrust generator has a non-circular shape.

12. The aircraft of claim 11, wherein the thrust generator comprises a flat device.

13. The aircraft of claim 11, wherein the plurality of fluid injection devices comprises a plurality of fluidic oscillators configured to inject pulsed jets of the exhaust gas radially into the thrust generator and along the Coanda profile surface at a predetermined modulated frequency.

14. The aircraft of claim 11, wherein the plurality of fluid injection devices comprises a plurality of nozzles configured to direct the exhaust gas radially into the thrust generator and along the Coanda profile surface.

15. The aircraft of claim 14, wherein each nozzle among the plurality of nozzles comprises one or more nozzle vanes; wherein the one or more nozzle vanes are actuated to alter size of an exit of each nozzle.

16. The aircraft of claim 15, wherein the one or more nozzle vanes are actuated to reduce the size of the exit of each nozzle so as to accelerate the injection of the exhaust gas radially into the thrust generator and along the Coanda profile surface during take-off operating condition of the aircraft.

17. The aircraft of claim 15, wherein the one or more nozzle vanes of each nozzle are selectively actuatable in such a way that only some nozzles among the plurality of nozzles inject the exhaust gas into the thrust generator.

18. A method for generating thrust, comprising:
introducing air via an air inlet with a non-circular thrust generator;
directing exhaust gas from a gas generator to a plenum;
injecting the exhaust gas from the plenum via the plurality of fluid injection devices radially into the thrust generator and along a Coanda profile surface configured to facilitate attachment of the exhaust gas to the profile surface to form a boundary layer and to entrain incoming air from the air inlet.

19. The method of claim 18, comprising injecting pulsed jets of the exhaust gas radially into the thrust generator and along the Coanda profile surface at a predetermined modulated frequency via the plurality of fluid injection devices comprising a plurality of fluidic oscillators.

20. The method of claim 18, comprising injecting the exhaust gas radially into the thrust generator and along the Coanda profile surface via the plurality of fluid injection devices comprising a plurality of nozzles.

21. The method of claim 20, further comprising actuating one or more nozzle vanes of each nozzle to reduce size of an exit of each nozzle so as to accelerate the injection of the exhaust gas radially into the thrust generator and along the Coanda profile surface.
